(19) United States
(12) Patent Application Publication
(10) Pub. No.: US 2005/0205696 A1
(43) Pub. Date: Sep. 22, 2005

(54) Deposition apparatus and method

(75) Inventors: Yasuyuki Saito, Kawasaki-shi (JP); Junri Ishikura, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/078,302

(22) Filed: Mar. 14, 2005

(30) Foreign Application Priority Data
Mar. 19, 2004 (JP) 2004-080649

(51) Int. Cl. B05B 1/00

(52) U.S. Cl. 239/592; 239/597; 239/337; 239/594

(57) ABSTRACT

A nozzle has an inlet opening connected to a carrier pipe, an outlet opening for spraying an aerosol, and an aerosol-flow-controlling portion positioned between the inlet opening and the outlet opening. The aerosol-flow-controlling portion of the nozzle has an area which is smaller than an area of the inlet opening and which is larger than an area of the outlet opening to deposit a film with a uniform thickness.

### BACKGROUND OF THE INVENTION

1. Field of the Invention

The present invention relates to a deposition method and an apparatus for forming various devices by aerosolizing fine particles and spraying the aerosolized particles onto a substrate.

2. Description of the Related Art

A gas deposition method is a conventionally known deposition method. According to this method, particles including a deposition material are aerosolized and sprayed onto a deposition surface, thus allowing the particles to impinge on the deposition surface. The gas deposition method is classified into a gas evaporation method and an aerosol deposition method according to the particular preparation method of the aerosol (see Japanese Patent Laid-Open Nos. 1-285525, 59-80361, 1-288525, 7-51556, and 2003-251227). In the gas evaporation method, the deposition material in a gas (carrier gas) is evaporated and the formation of an aerosol and of particles is almost simultaneously performed. On the other hand, in the aerosol deposition method, an aerosol is formed using particles of the deposition material that are prepared in advance.

FIG. 1 is a schematic diagram of a conventional deposition apparatus based on the gas evaporation method. In FIG. 1, an evaporation source 5 of a deposition material (for example, a metal material) is heated by a heating electrode 4 in a particle-forming chamber 1. A non-oxidizing gas 7 is introduced into the particle-forming chamber 1. Atoms of the deposition material evaporated by heating are rapidly cooled through, for example, collision with the non-oxidizing gas 7 to form ultrafine particles. A mechanism 6 evacuates excess particles. The particle-forming chamber 1 communicates with a film-forming chamber 2 through a carrier pipe (transport tube) 3. A vacuum pumping system 11 maintains a vacuum (depressurized state) in the film-forming chamber 2 to produce a pressure difference between the particle-forming chamber 1 and the film-forming chamber 2. This pressure difference causes particles formed in the particle-forming chamber 1 to move into the film-forming chamber 2 through the carrier pipe 3 together with the non-oxidizing gas 7. These particles are ejected at a high rate onto a substrate (board) 9 from an opening provided at an end of a nozzle 8 attached to an end portion of the carrier pipe 3 in the film-forming chamber 2. The ejected particles impinge on the surface of the substrate 9 to deposit a film made of the components of the particles.

FIG. 2 is a schematic diagram of a conventional deposition apparatus based on the above aerosol deposition method. In FIG. 2, a blast of a carrier gas 7 such as an inert gas is sent to the bottom surface of a container 12 containing particles of a deposition material, such as a metal and an alloy, to aerosolize the particles in the container 12. The aerosol of the particles in the carrier gas 7 is sprayed onto a substrate (board) 9 through a carrier pipe 3 connected to the top of the film-forming chamber 2 from an opening provided at an end of a nozzle 8 connected to an end of the carrier pipe 3 in the film-forming chamber 2. As a result, the particles impinge on the substrate 9 to deposit a film made of the components of the particles. In FIG. 2, the substrate 9 is placed on a stage 10. A vacuum pumping system 11 maintains a vacuum (depressurized state) in the film-forming chamber 2 to produce a pressure difference between the container 12 and the film-forming chamber 2.

### SUMMARY OF THE INVENTION

According to conventional methods, if the area (longitudinal length) of the film to be deposited on a substrate is larger than the longitudinal length of an opening of a nozzle on its particle-ejection side, the nozzle or a stage holding the substrate must cycle many times while an aerosol is sprayed onto the substrate. The conventional methods therefore have the following problems. Note that the nozzle for ejecting particles has an opening (hereinafter also referred to as “outlet opening”) for ejecting particles onto the substrate and an opening (hereinafter also referred to as “inlet opening”) connected to a carrier pipe.
(1) The movement speed of the stage drops when it turns, thus decreasing the uniformity of the film thickness.
(2) When a film is deposited next to already covered (deposited) portions, it may or may not overlap the covered portions, thus decreasing the uniformity of the film thickness.
(3) The deposition of a large film involves a large number of turns of the stage, thus taking much time.

As a method for solving the above problems (1) to (3), the number of turns of the stage or the number of scans of the nozzle can be reduced simply by extending the longitudinal length (the width of the nozzle for ejecting particles) of the opening (rectangular outlet opening) of the nozzle on its particle-ejection side.

According to this method, however, the concentration of aerosol becomes higher at the center than at both ends of the rectangular outlet opening in the longitudinal direction. The resultant film is therefore thicker at positions with higher aerosol concentration and is thinner at positions with lower aerosol concentration. This makes it difficult to form a film with a uniform thickness.

When a wide nozzle is used, as disclosed in Japanese Patent Laid-Open No. 2003-251227 above, the nozzle needs a plurality of inlet openings, thus complicating the structure of a deposition apparatus. Accordingly, the use of a plurality of inlet openings by itself cannot necessarily provide a film with a highly uniform thickness.

To solve the above problems in the related art, the present invention provides a nozzle for depositing a film with a uniform thickness.

A deposition apparatus according to a first aspect of the present invention includes a carrier pipe and a nozzle provided at an end of the carrier pipe for spraying an aerosol, prepared by dispersing particles in a gas, onto a substrate through the carrier pipe to deposit a film made of components of the particles on the substrate. The nozzle has an inlet opening connected to the carrier pipe, an outlet opening for spraying the aerosol, and an aerosol-flow-controlling portion (an opening for controlling the flowing of aerosol) positioned between the inlet opening and the outlet opening. The aerosol-flow-controlling portion has an area smaller than the inlet opening and larger than the outlet opening.

A deposition apparatus according to a second aspect of the present invention includes a carrier pipe and a nozzle provided at an end of the carrier pipe for spraying an aerosol, prepared by dispersing particles in a gas, onto a substrate through the carrier pipe to deposit a film made of components of the particles on the substrate. The nozzle has an inlet opening connected to the carrier pipe, an outlet opening for spraying the aerosol, and an aerosol-flow-controlling portion (an opening for controlling the flowing of aerosol) positioned between the inlet opening and the outlet opening. The aerosol flow-controlling portion (opening for controlling the flowing of aerosol) has long sides (or a major axis) and short sides (or a minor axis). The long sides (or major axis) of the aerosol-flow-controlling portion are shorter than the long sides (or major axis) of the outlet opening. Also, the short sides (or minor axis) of the aerosol-flow-controlling portion are longer than the short sides (or minor axis) of the outlet opening.

A deposition method according to a third aspect of the present invention includes spraying an aerosol, prepared by dispersing particles in a gas, onto a substrate through a carrier pipe from a nozzle provided at an end of the carrier pipe to deposit a film made of components of the particles on the substrate, and causing the flow direction of the aerosol to change in an aerosol-flow-controlling portion of the nozzle to increase the dispersibility of the particles contained in the aerosol in the nozzle before the aerosol is sprayed from an end of the nozzle.

According to the first and second aspects of the present invention, the aerosol-flow-controlling portion, having an area smaller than the area of the inlet opening connected to the carrier pipe, can change the flow direction of the aerosol (containing particles) entering the nozzle through the carrier pipe. That is, the aerosol-flow-controlling portion has the effect of diffusing the particles contained in the aerosol to increase the uniformity of the particle concentration in the nozzle. In addition, the aerosol-flow-controlling portion has an area larger than the outlet opening area of the nozzle so that the pressure loss at the aerosol-flow-controlling portion becomes smaller than that at the outlet opening. This relieves the adverse influence caused by the aerosol-flow-controlling portion on the flow rate of the aerosol (namely the flow rate of the carrier gas and the particles) sprayed or ejected from the outlet opening of the nozzle.

The outlet opening of the nozzle is often rectangular or elliptical. In such cases, the aerosol-flow-controlling portion may have long sides (or a major axis) and short sides (or a minor axis). The long sides (or major axis) of the aerosol-flow-controlling portion are configured to be shorter than the long sides (or major axis) of the outlet opening. The short sides (or minor axis) of the aerosol-flow-controlling portion are configured to be longer than the short sides (or minor axis) of the outlet opening. Consequently, the above effect may be achieved.

As described above, the present invention provides a deposition apparatus including a nozzle for spraying an aerosol prepared by dispersing particles in a gas. The aerosol is carried and sprayed (ejected) from the nozzle to impinge on a substrate, thus depositing a film on the substrate. The nozzle has an internal shape capable of changing the flow direction of the aerosol (particles) to increase the dispersibility of the particles, thus depositing a film with a highly uniform thickness. In addition, the nozzle has a particle-dispersion mechanism. Accordingly, even with a small inlet opening and a large outlet opening, this nozzle can provide the aerosol at a uniform concentration to deposit a film with a highly uniform thickness.

Further features and advantages of the present invention will become apparent from the following description of exemplary embodiments (with reference to the attached drawings).

### BRIEF DESCRIPTION OF THE DRAWINGS

FIG. 1 is a schematic diagram of a conventional apparatus for depositing an ultrafine particle film according to a gas evaporation method;

FIG. 2 is a schematic diagram of a conventional apparatus for depositing a fine particle film according to an aerosol deposition method;

FIG. 3 is a sectional view of a nozzle according to the present invention; and

FIG. 4 is a perspective view of a nozzle in use according to the present invention.

### DESCRIPTION OF THE EMBODIMENTS

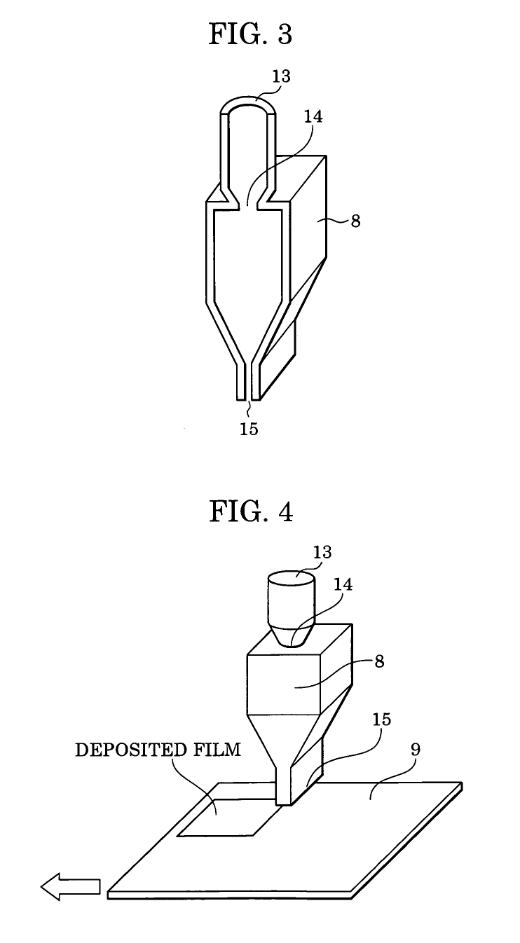

Preferred embodiments of the present invention will now be described in detail with reference to the drawings. FIG. 3 is an example of a sectional view of a nozzle 8 according to the present invention. In this embodiment, the nozzle 8 has a rectangular outlet opening 15 (the above second aspect of the present invention may be applied to this case). The second aspect of the present invention may also be applied to nozzles having an outlet opening having a shape, such as an elliptical shape, with a length-to-width ratio of more or less than 1.

The above first aspect of the present invention (in which the aerosol-flow-controlling portion has an area smaller than an area of the inlet opening of the nozzle and larger than an area of the outlet opening of the nozzle) may be applied not only to nozzles having an outlet opening having, for example, a rectangular or elliptical shape, with a length-to-width ratio of more or less than 1, as shown in FIG. 3, but also to nozzles having an outlet opening having, for example, a circular or square shape, with a length-to-width ratio (aspect ratio) of approximately 1 (within the range of 0.7 to 1.4 for practical use).

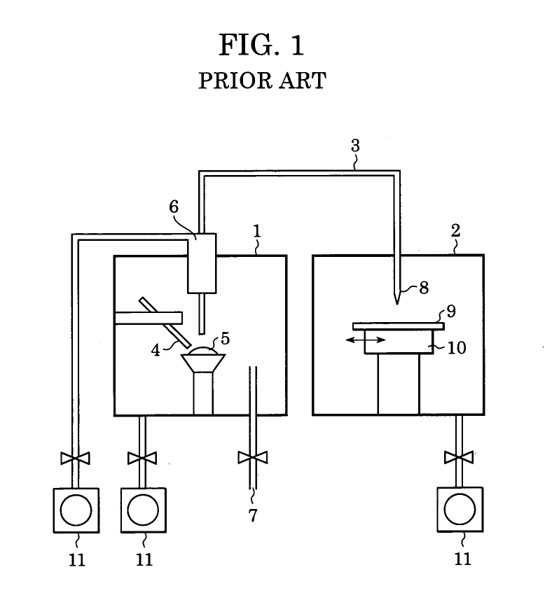

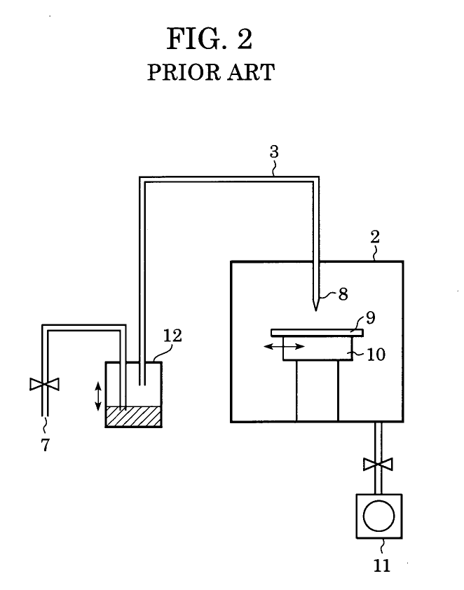

The present invention may be applied to either a gas evaporation method, in which a deposition material is evaporated into fine particles to prepare an aerosol, as described with reference to FIG. 1, or an aerosol deposition method, in which particles of a deposition material that are prepared in advance are aerosolized, as described with reference to FIG. 2.

A deposition apparatus according to the present invention includes a first chamber (corresponding to the chamber 1 in FIG. 1 and the container 12 in FIG. 2) for preparing an aerosol, a second chamber (corresponding to the chamber 2 in FIGS. 1 and 2) for depositing a film on a substrate, a carrier pipe (corresponding to the carrier pipe 3 in FIGS. 1 and 2) for communication between the first and second chambers, a pressure controller (corresponding to the vacuum pumping system 11 in FIGS. 1 and 2) for keeping the pressure in the second chamber lower than that of the first chamber, and a nozzle 8, which is provided at an end portion of the carrier pipe. The second chamber preferably includes a stage 10 for holding the substrate 9 and adjusting the position of the substrate 9 relative to the nozzle 8.

The shape of the nozzle 8 according to the present invention will now be described in detail with reference to FIG. 3. The nozzle 8 according to the present invention has an inlet opening 13 for introducing an aerosol into the nozzle 8, an outlet opening 15 for spraying (ejecting) the aerosol onto a substrate 9, and an aerosol-flow-controlling portion 14 provided between the inlet opening 13 and the outlet opening 15 for controlling the flowing of aerosol in the nozzle 8.

The aerosol-flow-controlling portion 14, having an area smaller than the inlet opening 13 connected to the carrier pipe 3, can diffuse a flow of aerosol passing through the aerosol-flow-controlling portion 14 from the carrier pipe 3 in the space between the aerosol-flow-controlling portion 14 and the outlet opening 15 (in other words, the aerosol-flow-controlling portion 14 has the effect of changing the direction of the flow). An area of the space between the aerosol-flow-controlling portion 14 and the outlet opening 15 is preferably larger than the area of the aerosol-flow-controlling portion 14. The aerosol-flow-controlling portion 14 can therefore disperse the particles in the nozzle 8. In addition, the aerosol-flow-controlling portion 14, having an area larger than an area of the outlet opening 15 of the nozzle 8, can reduce the pressure loss at the aerosol-flow-controlling portion 14 to inhibit the undesired effect on the flow of the aerosol sprayed onto the substrate 9 from the nozzle 8. The term “area” used in the present invention may be defined as a cross-sectional area which is perpendicular to the flow direction of the aerosol, or a cross-sectional area which is perpendicular to an imaginary line passing through the centers of the inlet opening 13, the aerosol-flow-controlling portion 14, and the outlet opening 15.

The nozzle 8 may have any shape between the inlet opening 13 and the aerosol-flow-controlling portion 14 and between the aerosol-flow-controlling portion 14 and the outlet opening 15. For increasing the dispersibility of particles in the nozzle 8 (in the nozzle area), it is preferable that the area (cross-sectional area in a plane perpendicular to the flow direction of the aerosol or to the imaginary line), which is located between the aerosol-flow-controlling portion 14 and the outlet opening 15, of the nozzle 8 is larger than that of the aerosol-flow-controlling portion 14. In addition, for further increasing the dispersibility of particles in the nozzle 8 (in the nozzle space), the distance between the aerosol-flow-controlling portion 14 and the outlet opening 15 may be preferably longer than the distance between the inlet opening 13 and the aerosol-flow-controlling portion 14.

According to the above method for depositing a film, aerosolized fine particles can be uniformly dispersed in the nozzle 8. As a result, a highly uniform aerosol can be ejected (sprayed) from the outlet opening 15 of the nozzle 8 to deposit a film with a highly uniform thickness.

FIG. 4 is a perspective view of the nozzle in use according to the present invention. Using the nozzle according to the present invention, a highly uniform film can be deposited on a large substrate 9 without the need for the reciprocation or cycling of the stage 10 many times. In addition, any desired pattern may be formed by a single process using the nozzle according to the present invention and a mask, which is arranged between the nozzle and the substrate, having an opening corresponding to the desired pattern.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-080649 filed Mar. 19, 2004, which is hereby incorporated by reference herein.

1. A deposition apparatus comprising:
a carrier pipe; and
a nozzle provided at an end of the carrier pipe for spraying an aerosol, said aerosol prepared by dispersing particles in a gas, onto a substrate through the carrier pipe to deposit a film comprising components of the particles on the substrate, the nozzle comprising:
an inlet opening connected to the carrier pipe;
an outlet opening for spraying the aerosol; and
an aerosol-flow-controlling portion positioned between the inlet opening and the outlet opening and having an area smaller than the inlet opening and larger than the outlet opening.

2. A deposition apparatus comprising:
a carrier pipe; and
a nozzle provided at an end of the carrier pipe for spraying an aerosol, said aerosol prepared by dispersing particles in a gas, onto a substrate through the carrier pipe to deposit a film comprising components of the particles on the substrate, the nozzle comprising:
an inlet opening connected to the carrier pipe;
an outlet opening for spraying the aerosol; and
an aerosol-flow-controlling portion positioned between the inlet opening and the outlet opening, the aerosol-flow-controlling portion having long sides or a major axis which is shorter than long sides or a major axis of the outlet opening, and having short sides or a minor axis which is longer than short sides or a minor axis of the outlet opening.

3. A deposition method comprising:
spraying an aerosol, prepared by dispersing particles in a gas, onto a substrate through a carrier pipe from a nozzle provided at an end of the carrier pipe to deposit a film comprising components of the particles on the substrate; and
causing the flow direction of the aerosol to change in an aerosol-flow-controlling portion of the nozzle to increase the dispersibility of the particles contained in the aerosol in the nozzle before the aerosol is sprayed from an end of the nozzle.
